(19) United States
(12) Patent Application Publication
(10) Pub. No.: US 2004/0078313 A1
(43) Pub. Date: Apr. 22, 2004

(54) Method of allocating funds among a plurality or requests for grant

(76) Inventors: Claude Brouillette, Montreal (CA); Lucie Girard, Saint-Augustin-de-Desmaures (CA); Daniel Desjardins, Saint-Augustin-de-Desmaures (CA); Abder Loukili, Sillery (CA); Adil Hamdouna, Longueuil (CA); Jacques Crochetiere, St-Redempteur (CA)

Correspondence Address: DEVINE, MILLIMET & BRANCH, P.A., 111 AMHERST STREET, BOX 719, MANCHESTER, NH, 03105, US

(21) Appl. No.: 10/269,452

(22) Filed: Oct. 11, 2002

(51) Int. Cl. G06F 17/60

(52) U.S. Cl. 705/36

(57) ABSTRACT

The method is provided for allocating funds among a plurality of requests for grant. In this method, a user web interface allows a user to fill out a request for grant and generate a set of data to be sent to a server. Verifications are made to determine whether the set of data does conform to a minimum number of criteria in order for the request for grant to be admissible. Upon determining that the request for grant is admissible, the set of data concerning the request for grant is made available to members of a review panel using a panel member web interface. Evaluation data from the panel members are eventually received at the server and combined together to create a draft evaluation which can be consulted by all panel members. Panel members are allowed to edit their evaluation data. At the end, a final evaluation of the request for grant is generated and sent to a governing body responsible for final funding allocation decisions. The governing body will issue the final funding allocation decisions based at least in part on the evaluations received from panel members. This method greatly improves the speed and the fluidity of the evaluation process compared to the traditional method. It also allows most, if not all, steps to be conducted using workstations connected to a network such as the Internet.

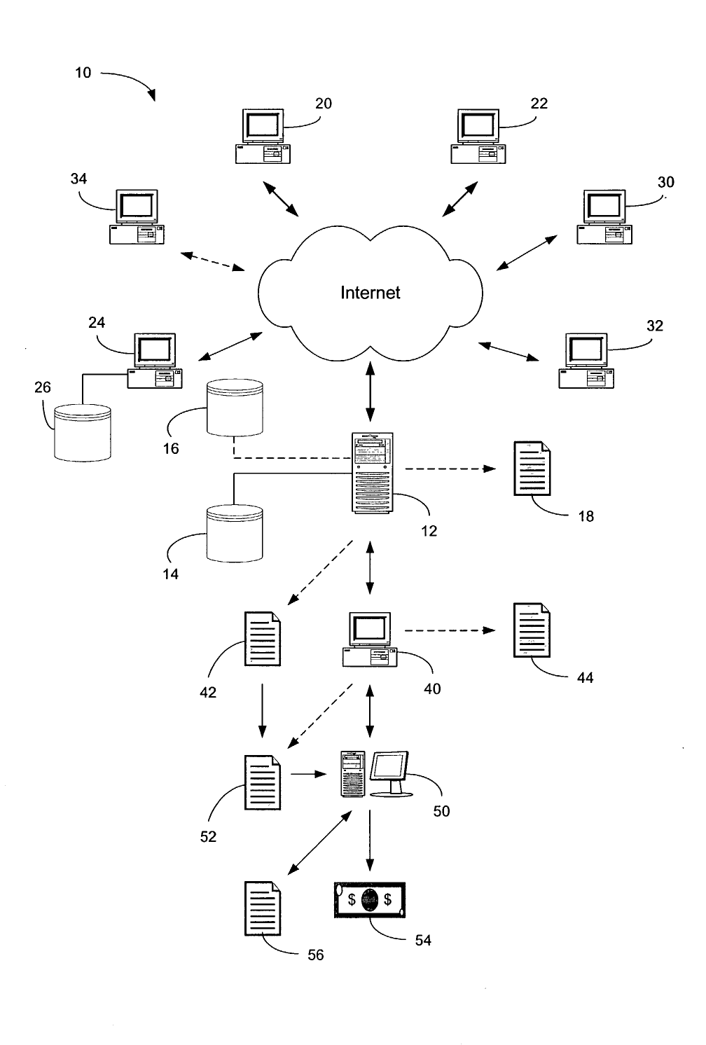

### BACKGROUND

Each year, governments and other organizations around the world allocate billions of dollars to subsidize individuals and corporations for a wide variety of reasons. These grants are generally allocated because of the existence of a program, a fund or a special budget devoted to such financial aid. For instance, grants are commonly allocated for research projects, social assistance or scholarships. Grants are also allocated for numerous other reasons.

In the majority of cases, a grant is allocated only if a proper request is completed and accepted. Such request, hereafter referred to as a “request for grant”, is almost always a paper form which must be filled out by someone, either for its own benefit or for the benefit of someone else or an organization willing to obtain a grant. Typically, once the request for grant is received at an appropriate location, data concerning the request for grant is manually entered in a database. The resulting set of data or the paper form itself is used during an evaluation conducted to determine if funds can be allocated or not.

Depending on the situation, some requests for grant are evaluated by only one person or by a review panel composed of two or more persons. The person or the review panel reviews each or some of the requests for grant and must at least determine whether it is or they are acceptable or not. As such, each request for grant must conform to a minimum number of criteria in order to be admissible. An evaluation of the request for grant, either in the form of a report, an entry in a table, etc. will need to be issued as a result or this evaluation. Requests for grant which do not conform to the minimum number of criteria or which are otherwise not acceptable will either simply be rejected or be returned to their sender for modifications. This traditional evaluation process is generally suitable in instances where criteria are very straightforward, which is, for instance, generally the case for requests for grant concerning social assistance. However, in other sectors, such as research programs, the evaluation process of requests for grant is much more complex and requires a review panel. Expert consultants may also be called upon to assist the review panel.

Traditionally, each member of a review panel receives a paper copy of the requests for grant for conducting his or her independent review. Their evaluations are then communicated back to a coordinator. If required, a meeting or a telephone conference is organized for a discussion among panel members. During the discussion, panel members usually review all requests for grant one by one and seek a consensus in their evaluation. The discussions are thus usually focused one the requests for grant where there are divergent initial evaluations. Once the discussions are completed, a final version of the evaluation is issued. This final evaluation is ultimately sent to a governing body and indicates, among other things, whether funds should be allocated or not. A governing body is generally a board of directors but can also be a single person. The governing body then takes the final decision concerning the funding allocations. The final funding allocation decisions takes into account various factors, such as the available budget and the number of requests for grant for which funding was recommended by their review panel. In some cases, it may be decided in advance that any positive evaluation is immediately accepted without further consideration.

One drawback of the conventional method of allocating funds is that filling the paper forms is generally a very lengthy and time-consuming process for the requesters, particularly in complex cases such as research projects. This waste of time is further amplified in cases where a request for grant must be filled out regularly for the renewal of a grant or if the research project qualifies for different programs or funds. There is also a waste of time at the receiving end since the data on the forms must generally be captured in a database.

Another drawback of the conventional method is the fact that it may become difficult and costly to manage the system in a context where there are many requests for grant in areas where complex aspects must be understood and analyzed. One example in the evaluation of requests for grant concerning research projects. The panel members must be able to fully assess the scope and relevancy of the research projects under review. They are thus often specialists in their fields and accordingly, they are not necessarily geographically close to each other. The fact that remotely-located panel members are appointed generally complicates the process, particularly the discussions towards the final evaluation. It may also be difficult and costly to exchange documents with these remotely-located persons or have them in a same meeting.

A further drawback of the conventional method is that when meetings are organized to discuss the initial evaluation of requests for grant, the requests for grant must be reviewed one by one. There is thus a significant waste of time since the panel members must expose their evaluation to others before they can realize that there is a consensus.

In view of all of the above, there was clearly a need for a method capable of allowing a more efficient and seamless process for evaluating a request for grant, particularly in the context where funds are to be allocated among a plurality of requests for grant.

### SUMMARY

It is an object of the present invention to provide an improved method of allocating funds among a plurality of requests for grant, most of which is implemented in computers and allow proceeding efficiently using the interconnectivity of a network such as the Internet. This method greatly improves the speed and the fluidity of the evaluation process. It also significantly lowers, even avoids, the recourse to most paper forms and thus the need of manually capturing data at the receiving end. Moreover, it can save a significant amount of time to panel members by allowing them to focus on only the requests for grant for which there are diverging opinions.

Other objects, aspects and advantages of the present invention will be more readily understood upon reading the following detailed description, which is made with reference to the unique FIGURE described hereafter.

### BRIEF DESCRIPTION OF THE FIGURE

The unique FIGURE is a schematic view of a preferred embodiment of a system capable of carrying out the method in accordance with the present invention.

### DETAILED DESCRIPTION

To obtain a grant, thus the allocation of funds, requestor must at least fill out a form referred to as a “request for grant” or have someone fill it. Unlike the traditional method, which generally required paper forms to be filled out, the requests for grant in the present invention are filled out using a user web interface provided by or on behalf of a funding organization. The funding organization is typically a government, an agency, a parapublic or non-profit organization. It could also be a profit-seeking organization or even an individual. The requester, which is hereafter generally referred to as being a “user”, preferably connects to the Internet in order to access the user web interface and then provide the required data.

The user web interface can be anything from a simple HTML form in which data are to be entered, to a fully-dynamic wizard which guides the user step-by-step and adapts displays to the actual context. All this allows the user to provide the required data, thus proceed with the preparation of the request for grant. It should be noted at this point that the invention is not necessarily limited to its use with the Internet. The expression “web interface” refers to any interface conveniently available to a user and which allows to transmit information over a network.

The enclosed FIGURE depicts an example of a system adapted to carry out the present invention. This system (10) generally includes a plurality of workstations and other electronic devices scattered in a wide area, most of which are interconnected through the Internet. They could also be connected to another kind of network. One important component is the main server (12) at which most activities are carried out. It should be noted that the reference to a “server” does not mean that it must necessarily be a single computer. The “server” (12) could actually be an array of servers. The server (12) is coupled to a database (14) in which are recorded the data. The exchange of data from the user web interface to the server (12) is preferably made using encryption and authentication methods, including the need of providing an access code and/or a password.

In the FIGURE, user1 (20) and user2 (22) connect to the server (12) to obtain the user web interface required for completing their respective request for grant. They each complete the required information and then individually send their own set of data gathered at the user web interface to the server (12) over the Internet.

At one point, it must be determined whether data provided by any one of the users (20,22) do conform or not to a minimum number of criteria in order for the requests for grant to be admissible. This could be carried out in a number of ways. For instance, the user web interface could be programmed to only send data to the server (12) if a minimum number of fields is completed. Other criteria could be programmed. For instance, the citizenship of a user and the level of required funding can be important aspects. This conformity determination could also be done at the server (12), even once the information is recorded in the database (14). Parts of the verification can be done manually if desired or required.

Preferably, the conformity of the request for grant is determined at the user web interface itself and once the set of data reaches the server (12). If a problem is detected, users are notified by a message, for instance a message displayed in the user web interface itself or by an e-mail message. A user could also be notified using other methods, such as telephone, fax or mail.

In some instances, it may be necessary to contact a third party (24) in order to further verify some information. For instance, in the case of scholarships, it may be required to contact a university or another educational institution to verify if a person is a full time student or not. It may also be that a researcher must need the approval of a university or a research center to obtain a grant. This additional verification can be done electronically, using for instance an Extranet. The third party (24) verifies the information in a database (26) and then sends a response back to the server (12).

Upon determining that a request for grant is admissible, its set of data is electronically made available to panel members for an evaluation thereof. Depending on the cases, the review panel can be a “permanent” panel or a review panel specifically tailored for each request for grant. Members of a permanent review panel can be people whose daily task is to evaluate requests for grant. On the other hand, especially in the case of requests for grant concerning research projects, the participation of at least some experts as members of the review panel is usually required or desired. Each funding organization or funding program has its own criteria for creating a review panel. In the illustrated example, Member1 (30) and Member2 (32) form the review panel.

Each panel member (30,32) has access through a panel member web interface to at least some of the set of data concerning each request for grant, therefore allowing to conduct his or her review. The provided set of data could simply be the raw data from the original request for grant itself, a subset of this data or, more preferably, data taken from the original request for grant and additional information. The added information is preferably a second set of data coming from another database (16), for instance a personal information database to which the funding organization has access. As an example, in the case of research programs, researchers need to be identified in requests for grant. However, instead of entering complete personal information on each researcher, it is more advantageous to refer to information pre-recorded in the other database (16). Many benefits are obtained when using a separate database (16), particularly for personal profiles. Among other things, this saves time to a user completing a request for grant since that person only has to make a reference to an identification number. It also prevents the funding organization from having to enter and possibly verify all this information. Nevertheless, one can choose to require such data or to allow the information to be entered if this is the first time someone contacts the funding organization or a group to which it is associated. Another advantage of consulting another database (16) is that if it is a personal profile database, panel members or expert consultants may be chosen using the information contained therein.

As aforesaid, data are sent to panel members (30,32) using a panel member web interface. Each panel member (30,32) can then conduct the whole evaluation of the request for grant through this interface. However, if necessary, a panel member (30,32) should be allowed to print data if that is more convenient for him or her to do so. The panel member web interface can be divided in a plurality of sections, for instance one for receiving data and one for providing the evaluation data. Advantageously, it should be as simple as possible, include the various criteria for immediate consultation and possibly include standardized evaluation tables.

If required, an expert consultant (34) may be used to help the review panel. This expert consultant (34) would only be asked to provide comments using an expert web interface. Other communication means are also possible.

Once the review is completed by a panel member, the evaluation data are preferably sent back to the server (12) using the panel member web interface. Encryption is preferably used at the stage, particularly if communications are made using the Internet. The evaluation data sent by the panel members (30,32) could be as simple as a yes or no response, or be more elaborated, for instance including comments or questions. At one point, each panel member (30,32) should be able to at least indicate whether it agrees to the fundability of the request for grant or not. Depending on the cases, each panel member (30,32) may also give a rating, for example a number or a letter which rates the request for grant. If many requests for grant are evaluated by a same review panel, they may also need to give a ranking among them. They can further be allowed to suggest or to make comments on the funding level.

Once received at the server (12), evaluation data from the panel members (30,32) are combined to form an initial or draft version of an evaluation of the request for grant. It should be noted that there may be a distinct evaluation for each request for grant or global evaluation for all of them, in which case data concerning each request for grant would appear in a table or the like.

Preferably, each panel member (30,32) is allowed to consult evaluation data provided by the other members, either as soon as possible the information is available or after a predetermined date. One can also make evaluation data available only if all panel members (30,32) have completed their initial work. This approach is preferred since it is more likely to prevent subjective considerations and biais in favor of someone.

The sharing of thoughts and information is made very easily with the present invention, thereby facilitating the work of the review panel. Yet, at one point, the opinion of some panel members (30,32) may diverge. A discussion among panel members (30,32) may then be conducted in order to seek a consensus. With the present invention, the requests for grant for which there was no consensus can be easily identified and discussions could take place only on them. These discussions could be done with all panel members (30,32) being present at the same time or be done using messages exchanged through the panel member web interface at different periods. A combination of both is also possible. What is a consensus should be defined in advance so that one could be easily identified as such. For instance, a consensus could be found using the relative difference between the highest score and the minimum score given by panel members (30,32). Sophisticated statistical techniques may be used as well, all of which depend on the specific needs and the context.

One important advantage of this system (10) is that the draft evaluation of a request for grant may be updated in a real time to reflect decisions taken after the discussions among panel members (30,32). These decisions could be taken after live discussions between two or more panel members (30,32), or taken by a panel member (30,32) after reading the evaluation of others. At the end of the process, a final evaluation is issued and sent to the governing body responsible for final funding allocation decisions. This is preferably done electronically, the evaluation or evaluations being sent directly to a workstation (40) of the governing body. This could also be done using an evaluation report or reports in paper form (42).

The governing body is responsible for final funding allocation decisions, as explained earlier. They may receive evaluations from one or a plurality of review panels. It may still issue a refusal (44) in spite the fact that the review panel or panels had agreed to the fundability of some of the requests for grant at an earlier stage of the process. For instance, the governing body may decide that the funds are allocated only to a certain number of requests for grant, the others being rejected. Contacts with the users (20,22) by the governing body may also be done by e-mail or using another communication means. It may even be done using a general web page.

In cases where the governing body decides that the funds should be allocated, the information concerning the allocations are transmitted to a financial system (50). Again, this is preferably done using an electronic exchange of information. It could also be done through an exchange of paper documents (52). The financial system (50) will proceed with the payment processing in accordance with the instructions of the governing body and agreed procedures. For instance, the grant may be in the form of a single check (54). It may also be given in the form of a plurality of checks for smaller amounts. Moreover, some funding programs may require that a follow up report (56) be issued from time to time. This could be done using an exchange of e-mails, or even through a web interface. Follow up reports (56) are usually requested to verify if the funds are spent properly by the beneficiary.

What is claimed is:

1. A method of allocating funds among a plurality of requests for grant, the method comprising:
providing a user web interface allowing to fill out each request for grant and generating a set of data;
receiving the set of data at a server and creating a record for the request for grant in a database;
determining whether the set of data does conform to a minimum number of criteria in order for the request for grant to be admissible;
upon determining that the request for grant is admissible, providing access to at least some data in the set of data concerning the request for grant to each member of the review panel using a panel member web interface;
receiving, from each member of the review panel through the panel member web interface, evaluation data concerning the request for grant;
making the evaluation data available to all members of the review panel;
allowing members of the review panel to edit their evaluation data;
creating a final evaluation of the request for grant and sending it to a governing body responsible for final funding allocation decisions; and
at the governing body, issuing the final funding allocation decisions to allocate the funds among the plurality of requests for grant, the final funding allocation decisions being based at least in part on the final evaluations of the plurality of requests for grant.

2. A method according to claim 1, wherein the final evaluation comprises data indicative of a rating.

3. A method according to claim 1, wherein the final evaluation comprises data indicative of a recommended funding level.

4. A method according to claim 1, further comprising:
sending the final funding allocation decisions, including data indicative of a level of funding approved by the governing body, to a financial system for payment processing.

5. A method of allocating funds among a plurality of requests for grant, the method comprising:
providing a user web interface allowing to fill out each request for grant and generating a first set of data, at least some of the data in the first set of data identifying at least one participant named in the request for grant;
receiving the first set of data at a server;
associating the data identifying at least one participant named in the request for grant with personal data previously recorded in a personal information database;
generating a second set of data comprising at least some of the data from the first set of data and at least some of the associated personal data;
determining whether the second set of data does conform to a minimum number of criteria in order for the request for grant to be admissible;
upon determining that the request for grant is admissible, providing access to at least some data in the second set of data to each member of the review panel using a panel member web interface;
receiving at the server, from the members of the review panel using the panel member web interface, evaluation data concerning the request for grant;
creating a draft evaluation by combining the evaluation data received from the members of the review panel;
allowing members of the review panel to edit their evaluation data;
creating a final evaluation of the request for grant and sending it to a governing body responsible for final funding allocation decisions; and
at the governing body, issuing the final funding allocation decisions to allocate the funds among the plurality of requests for grant, the final funding allocation decisions being based at least in part on the final evaluations of the plurality of requests for grant.

6. A method according to claim 5, wherein the final evaluation comprises data indicative of a rating.

7. A method according to claim 5, wherein the final evaluation comprises data indicative of a recommended funding level for at least some of the requests for grant.

8. A method according to claim 5, further comprising:
sending the final funding allocation decisions, including data indicative of a level of funding approved by the governing body, to a financial system for payment processing.

9. A method according to claim 5, further comprising:
selecting at least some of the members of the review panel from an expert database.

10. A method according to claim 9, wherein the expert database is a subset of the personal information database.

11. A method of allocating funds among a plurality of requests for grant, the method comprising:
providing a user web interface allowing to fill out each request for grant and generating a first set of data, at least some of the data in the first set of data identifying at least one participant named in the request for grant;
receiving the first set of data at a server;
associating the data identifying at least one participant named in the request for grant with personal data previously recorded in a personal information database;
generating a second set of data comprising at least some of the data from the first set of data and at least some of the associated personal data;
determining whether the second set of data does conform to a minimum number of criteria in order for the request for grant to be admissible;
upon determining that the request for grant is admissible, providing access to at least some data in the second set of data to each member of the review panel using a panel member web interface;
receiving at the server, from the members of the review panel, evaluation data concerning the request for grant;
creating a draft evaluation by combining the evaluation data received from the members of the review panel, the draft evaluation indicating whether there is a consensus between members of the review panel;
updating the draft evaluation in real time to reflect decisions taken after the discussions among members of the review panel;
creating a final evaluation of the request for grant and sending it to a governing body responsible for final funding allocation decisions; and
at the governing body, issuing the final funding allocation decisions to allocate the funds among the plurality of requests for grant, the final funding allocation decisions being based at least in part on the final evaluations of the plurality of requests for grant.

12. A method according to claim 11, wherein the final version of the evaluation comprises data indicative of a rating.

13. A method according to claim 11, wherein the final evaluation comprises data indicative of a recommended funding level for at least some of the requests for grant.

14. A method according to claim 11, further comprising:
sending the final funding allocation decisions, including data indicative of a level of funding approved by the governing body, to a financial system for payment processing.

15. A method according to claim 11, further comprising:
selecting at least some of the members of the review panel from an expert database.

16. A method according to claim 15, wherein the expert database is a subset of the personal information database.
